(19) United States
(12) Patent Application Publication
(10) Pub. No.: US 2022/0012636 A1
(43) Pub. Date: Jan. 13, 2022

(54) METHOD AND DEVICE FOR CREATING A SYSTEM FOR THE AUTOMATED CREATION OF MACHINE LEARNING SYSTEMS

(71) Applicant: Robert Bosch GmbH, Stuttgart (DE)

(72) Inventors: Marius Lindauer, Lehrte (DE); Arber Zela, Bad Krotzingen (DE); Danny Oliver Stoll, Freiburg (DE); Fabio Ferreira, Weingarten (DE); Frank Hutter, Freiburg Im Breisgau (DE); Thomas Nierhoff, Augsburg (DE)

(21) Appl. No.: 17/366,639

(22) Filed: Jul. 2, 2021

(30) Foreign Application Priority Data
Jul. 10, 2020 (DE) 102020208671.0

(51) Int. Cl. G06N 20/00; G06N 5/00; G06N 7/00

(52) U.S. Cl. CPC G06N 20/00; G06N 7/005; G06N 5/003

(57) ABSTRACT

Computer-implemented method for creating a system, which is suitable for creating in an automated manner a machine learning system for computer vision. The method includes: providing predefined hyperparameters; determining an optimal parameterization of the hyperparameters using BOHB (Bayesian optimization (BO) and Hyperband (HB)) for a plurality of different training data sets; assessing all optimal parameterizations on all training data sets of the plurality of different training data sets with the aid of a normalized metric; creating a matrix, the matrix including the evaluated normalized metric for each parameterization and for each training data set; determining meta-features for each of the training data sets; optimizing a decision tree, which outputs as a function of the meta-features and of the matrix which of the optimal parameterization using BOHB is a suitable parameterization for the given meta-features.

### CROSS REFERENCE

The present application claims the benefit under 35 U.S.C. § 119 of German Patent Application No. DE 102020208671.0 filed on Jul. 10, 2020, which is expressly incorporated herein by reference in its entirety.

### FIELD

The present invention relates to a method for creating a system, which is suitable for creating in an automated manner a machine learning system for computer vision, and to a corresponding computer program and to a machine-readable memory medium.

### BACKGROUND INFORMATION

A present-day challenge in machine learning is that for each training data set a hyperparameterization of the machine learning algorithm must be adjusted anew and on the basis of suppositions and experiences of experts. Without such an adjustment, the learning algorithm will converge to a sub-optimal approach or will be able to find no answer at all. This is extremely disadvantageous since, moreover, it is seldom possible to achieve an optimal parameterization of the hyperparameters by way of manual adjustment. Significant power losses of the machine learning systems trained thereby occur as a result.

There are approaches that attempt to overcome these disadvantages and, for example, determine the optimal hyperparameters for a given training data set with the aid of 102627398.1 machine learning methods, for example, of Falkner, Stefan, Aron Klein, and Frank Hutter “BOHB Robust and efficient hyperparameter optimization at scale” arXiv preprint arXiv: 1807.01774 (2018), retrievable online at https://arxiv.org/abs/1807.01774.

These approaches have the disadvantage, however, that their hyperparameterizations found are applicable only to a limited degree and also not optimally or reliably for similar data sets, for example, including a different number of classes or, for example, which contain images of a similar domain or of a similar classification problem.

### SUMMARY

The present invention may have the advantage over the related art that it provides a method for parameterizing in an automated and optimal manner a machine learning algorithm regardless of the domain, as well as associated machine learning systems. It is thus possible with the present invention to train machine learning systems in an automated manner, this learning algorithm being reliably applicable for a multitude of different data sets and, for example, optimal results being achieved regardless of the number of object classes and/or whether there are training images or training videos.

In one first aspect, the present invention relates to a computer-implemented method for creating a system, which is suitable for creating in an automated manner a machine learning system for computer vision (CV).

Computer vision may be understood to mean that the machine learning systems are configured to process and to analyze any type of images, videos or the like recorded by cameras in a variety of different ways. This may, for example, be a classification of the images or an object detection or a semantic segmentation.

In accordance with an example embodiment of the present invention, the method includes the following steps:

providing, in particular defining, a value range in each case of predefined hyperparameters. The hyperparameters may be widely different parameters and usually parameterize an optimization algorithm, in particular, a training algorithm, or their values are each assigned to one optimization algorithm of a plurality of widely different optimization algorithms. The hyperparameters include at least one first parameter, which characterizes which optimization method is used. The optimization methods may be stochastic optimizers such as, for example, Adam, AdamW or Nesterov accelerated gradient.

The hyperparameters further include a second parameter, which characterizes of what type the machine learning system is, in particular, which function approximator the machine learning system uses. The following types, for example, may be used: (preferably pre-trained) EfficientNet or simple classifiers such as SVM, uncorrelated random decision forests, a deep neural network or a logistic regression.

This is followed by a determination of an optimal parameterization of the hyperparameters with the aid of BOHB for each single training data set of a plurality of different training data sets for computer vision. The data sets may be referred to as meta-training data sets and are characterized in that these include input variables with assigned labels. The input variables may each be 4D tensors (time/column/row/channel). The labels are preferably vectors which characterize a class via a binary value or semantic segmentations. The data sets are preferably complementary to one another and the following publicly accessible data sets are particularly preferably used: Chucky, Hammer, Munster, caltech birds2010, cifar100, cifar10, colorectal histology and eurosat. Complementary may be understood here to mean that these include a widely different number of classes and/or contain images as well as videos, etc.

This is followed by an assessment of all optimal parameters on all training data sets of the plurality of different training data sets with the aid of a normalized metric. A normalized metric may, for example, be a classification accuracy or a runtime or a normalized loss function.

This is followed by a creation of a matrix, the matrix containing as inputs the evaluated normalized metric for each parameterization and for each training data set.

This is followed by a determination of meta-features for each of the training data sets, the meta-features characterizing at least the following properties of the training data sets: image resolution, number of classes, number of training data points/test data points, number of video frames. It is noted that the meta-feature ‘number of video frames’ for images may be set to the value 1.

Finally, an optimization of a decision tree follows, which outputs as a function of the meta-features and of the matrix which of the optimal parameterization with the aid of BOHB is a suitable parameterization for the given meta-features. The decision tree is optimized in such a way or its parameter is adjusted in such a way that, based on the provided meta-features and the matrix, this parameter determines which of the particular parameterizations with the aid of BOHB is the most suitable parameterization for the present meta-features. It is noted that the decision tree is a selection model.

The inventors have found that the combination of meta-learning and hyperparameter optimization results in high-grade domain-independent learning. In accordance with an example embodiment of the present invention, the method is further able to handle an above-average plurality of meta-training data sets and to extract therefrom with very little effort (via the decision tree) a suitable parameterization for given meta-features. The advantage of the decision tree is that it is quick and requires smaller amounts of data. Consequently, the meta-learner is relatively small and may be both trained and also operated within a few seconds.

In accordance with an example embodiment of the present invention, the system may be subsequently initialized, which is suitable for creating the machine learning system. The system then includes the decision tree, the system then initializing as a function of the output of the decision tree a machine learning system as well as an optimization algorithm for training the machine learning system. The system may then also train the machine learning system using this optimization algorithm.

In accordance with an example embodiment of the present invention, it is provided that the parameters of the decision tree are optimized with the aid of AutoFolio. AutoFolio is an algorithm that trains a selection model, which selects both a suitable optimization algorithm as well as its optimal configuration and is described by the authors M. Lindaur, H. Hoos, F. Hutter and T. Schaub in their paper “AutoFolio: An Automatically Configured Algorithm Selector,” Journal of Artificial Intelligence 53 (2015): 745-778, retrievable online at: http://ml.informatik.uni-freiburg.de/papers/17-IJCAI-AutoFolio.pdf. It has been shown namely that with the aid of AutoFolio, the decision tree is particularly efficiently and effectively applicable for machine learning systems for computer vision.

In accordance with an example embodiment of the present invention, it is further provided that an average value of the normalized metric is determined and, in particular, for all optimal hyperparameterizations across the plurality of training data sets, one of the determined parameterizations of the hyperparameters being selected with the aid of BOHB, which of the normalized metric comes closest to the average value, the evaluated normalized metric of this configuration for all training data sets being added to the matrix. In addition or alternatively, one of the determined parameterizations of the hyperparameters may be selected with the aid of BOHB which, for the normalized metric exhibits on average for all training data sets the greatest improvement of the normalized metric compared to the average value of the normalized metric.

This approach has the advantage that a robust parameterization is added, for which in fact no particular superior performance with respect to the evaluated normalized metric is to be expected, but the parameterization nevertheless achieves a good performance across all meta-training data sets. Thus, one parameterization is hereby available to the decision tree if none of the other optimal parameterizations are suitable.

In accordance with an example embodiment of the present invention, it is further provided that a subset of meta-features of the plurality of the meta-features is determined with the aid of a Greedy algorithm. This selection of a suitable subset of the meta-features has the advantage that redundant or even negatively influencing meta-features are removed, as a result of which the selection model becomes more reliable. In this case, it may be iteratively checked whether the decision of the model deteriorates with each of the selected subsets of the meta-features.

In accordance with an example embodiment of the present invention, it is further provided that after the creation of the selection model, a further training data set is provided. This is preferably an unknown training data set, which has not been used for creating the selection model, i.e., was not included in the meta-training data sets. The meta-features for the further training data set are subsequently determined, a suitable parameterization being subsequently determined using the selection model as a function of the meta-features and of the matrix. Based on this suitable parameterization, a machine learning system may then be created and may be trained on the further training data set, for example, with the aid of the aforementioned system.

In accordance with an example embodiment of the present invention, it is further provided that the machine learning system is created based on the first parameter of the hyperparameters, and an optimization algorithm for the machine learning system is selected based on the second parameter of the hyperparameters and parameterized in accordance with the selected configuration.

Alternatively, the output suitable parameterization may be optimized with the aid of the decision tree, again using a hyperparameter optimizer, preferably BOHB, and only then correspondingly parameterize therewith the machine learning system and/or the optimization algorithm.

Alternatively, a configuration may also be randomly drawn from the set of the configurations, or the further parameterization is invariably used, which on average achieves for all training data sets the greatest improvement of the normalized metric compared to the average value of the normalized metric.

It is noted that not all hyperparameters from the suitable parameterization need to be used. It may be that the hyperparameters are in part a function of one another, for example, not every type of machine learning system requires a weight decay.

In further aspects, the present invention relates to a computer program, which is configured to carry out the above methods and to a machine-readable memory medium, on which this computer program is stored.

### BRIEF DESCRIPTION OF THE DRAWINGS

Specific embodiments of the present invention are explained in greater detail below with reference to the figures.

FIG. 1 schematically shows a workflow of one exemplary embodiment of the present invention.

FIG. 2 schematically shows a flowchart of one specific embodiment of the present invention.

FIG. 3 schematically shows one exemplary embodiment for controlling an at least semi-autonomous robot, in accordance with the present invention.

FIG. 4 schematically shows one exemplary embodiment for controlling a manufacturing system, in accordance with the present invention.

FIG. 5 schematically shows one exemplary embodiment for controlling an access system, in accordance with the present invention.

FIG. 6 schematically shows one exemplary embodiment for controlling a monitoring system, in accordance with the present invention.

FIG. 7 schematically shows one exemplary embodiment for controlling a personal assistant, in accordance with the present invention.

FIG. 8 schematically shows one exemplary embodiment for controlling a medical imaging system;

FIG. 9 shows one possible design of a first training device 141, in accordance with the present invention.

### DETAILED DESCRIPTION OF EXAMPLE EMBODIMENTS

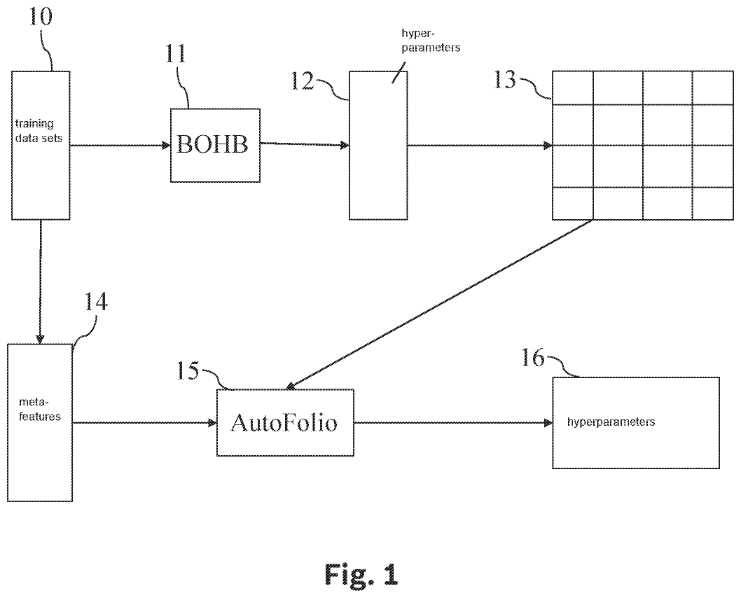

FIG. 1 schematically shows a workflow of one specific embodiment of the present invention. Prepared, different (meta-) training data sets 10 are initially provided. A set of hyperparameters is subsequently optimized for each of the different training data sets 10 with the aid of a hyperparameters optimizer 11, which is preferably BOHB. Optimal hyperparameters 12 are subsequently applied to all training data sets 10 and assessed with the aid of a normalized metric. The values of the normalized metric for each of the optimal hyperparameters 12 and for each of the training data sets 10 are subsequently entered into a matrix 13.

For each of training data sets 10, a set of meta-features 14 is extracted, which preferably uniquely characterizes the respective training data set 10. Meta-features 14 as well as matrix 13 are then subsequently provided to a meta-learner (AutoFolio) 15. This meta-learner 15 subsequently creates a decision tree, which is configured to select 16 those optimized hyperparameters 12 that are most suitable for the present meta-features 14 as a function of meta-features 14 and of matrix 13.

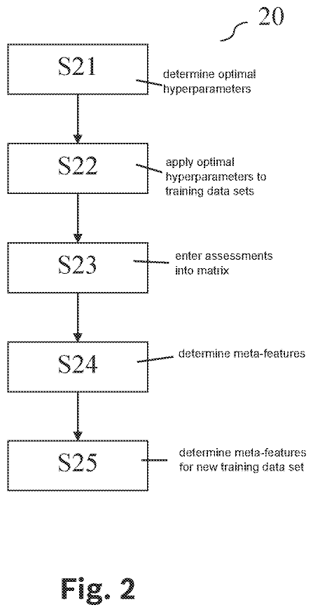

FIG. 2 schematically shows a flowchart 20 of one specific embodiment of the method according to the present invention.

The method starts with step S21. In this step, optimal hyperparameters 12 are determined 10 for one plurality each of different training data sets with the aid of BOHB 11.

In subsequent step S22, determined optimal hyperparameters 12 are then applied to all training data sets 10 used. In this case, these are then assessed with the aid of a normalized metric.

The assessments with the aid of the normalized metric are then entered into a matrix 13 in step S23. As a result, matrix 13 contains an entry for each data set 10 and for optimal hyperparameters 12, which corresponds to the value of the evaluated normalized metric for the respective data set and for the respective optimal hyperparameters.

In subsequent step S24, meta-features 14 for the training data sets are then determined. Meta-features 14 and matrix 13 are subsequently used by a meta-learner 15, preferably AutoFolio, in order to train therewith a decision tree, which is then able to select as a function of meta-features 14 and matrix 13 suitable hyperparameters 16 from optimal hyperparameters 12 which, for example, have been determined with the aid of BOHB.

Step S25 follows after the decision tree has been fully trained. In this step, meta-features 14 are determined for a new previously not seen training data set, which are subsequently added to the decision tree. The decision tree subsequently decides as a function of these fed meta-features 14 which of optimal hyperparameters 12 is most suitable for this not seen training data set. A machine learning system may then be subsequently initialized with the aid of the decision tree as a function of these selected hyperparameters and, in addition, an optimization algorithm may be initialized also as a function of the selected hyperparameters. The optimization algorithm may then subsequently train the initialized machine learning system based on the not seen training data.

The training data are preferably recordings of a camera, the machine learning system being trained for an object classification or object detection or semantic segmentation.

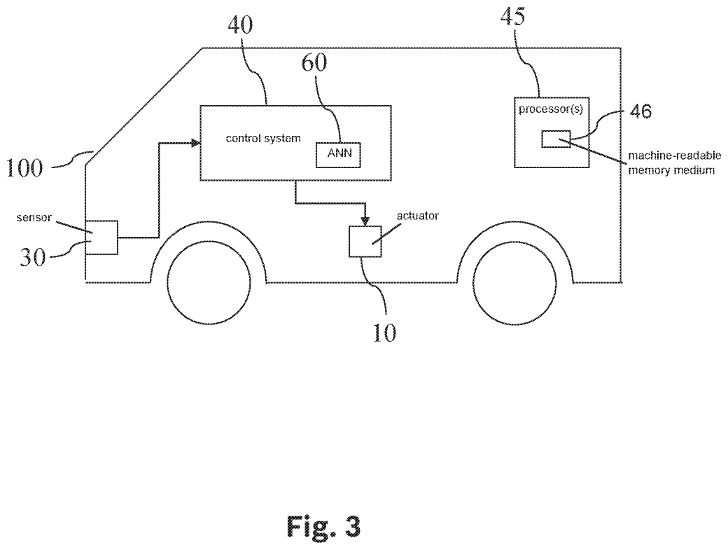

FIG. 3 shows an actuator 10 in its surroundings in interaction with a control system 40. The surroundings are detected at preferably regular temporal intervals in a sensor 30, in particular, in an imaging sensor such as a video sensor, which may also be provided by a plurality of sensors, for example, a stereo camera. Other imaging sensors are also conceivable such as, for example, radar, ultrasound or LIDAR. A thermal imaging camera is also conceivable. Sensor signal S—or one sensor signal S each in the case of multiple sensors—of sensor 30 is transmitted to control system 40. Control system 40 thus receives a sequence of sensor signals S. Control system 40 ascertains therefrom activation signals A, which are transferred to actuator 10.

Control system 40 receives the sequence of sensor signals S of sensor 30 in an optional receiving unit, which converts the sequence of sensor signals S into a sequence of input images x (alternatively, sensor signal S may in each case also be directly acquired as input image x). Input image x may, for example, also be a part or a further processing of sensor signal S. Input image x includes individual frames of a video recording. In other words, input image x is ascertained as a function of sensor signal S. The sequence of input images x is fed to the trained machine learning system from step S25, in the exemplary embodiment, an artificial neural network 60.

Artificial neural network 60 is preferably parameterized by parameters (1), which are stored in, and provided by, a parameter memory P.

Artificial neural network 60 ascertains output variables y from input images x. These output variables y may, in particular, include a classification and/or a semantic segmentation of input images x. Output variables y are fed to an optional forming unit, which ascertains therefrom activation signals A, which are fed to actuator 10 in order to activate actuator 10 accordingly. Output variable y includes pieces of information about objects that have been detected by sensor 30.

Actuator 10 receives activation signals A, is activated accordingly and carries out a corresponding action. Actuator 10 in this case may include a (not necessarily structurally integrated) activation logic, which ascertains from activation signal A a second activation signal with which actuator 10 is then activated.

In further specific embodiments of the present invention, control system 40 includes sensor 30. In still further specific embodiments, control system 40 alternatively or additionally also includes actuator 10.

In further preferred specific embodiments of the present invention, control system 40 includes a singular or a plurality of processors 45 and at least one machine-readable memory medium 46 on which the instructions are stored which, when they are executed on processors 45, then prompt control system 40 to carry out the method according to the present invention.

In alternative specific embodiments of the present invention, a display unit is alternatively or additionally provided in addition to actuator 10.

FIG. 2 shows how control system 40 may be used for controlling an at least semi-autonomous robot, here an at least semi-autonomous motor vehicle 100.

Sensor 30 may, for example, be a video sensor situated preferably in motor vehicle 100.

Artificial neural network 60 is configured to reliably identify objects from input images x.

Actuator 10 situated preferably in motor vehicle 100 may, for example, also be a brake, a drive or a steering of motor vehicle 100. Activation signal A may be ascertained in such a way that actuator or actuators 10 is/are activated in such a way that motor vehicle 100, for example, prevents a collision with the objects reliably identified by artificial neural network 60, in particular, if they are objects of particular classes, for example, pedestrians.

The at least semi-autonomous robot may alternatively also be another mobile robot (not depicted), for example, of a type which moves by flying, floating, diving or stepping. The mobile robot may, for example, also be an at least semi-autonomous lawn mower or an at least semi-autonomous cleaning robot. In these cases as well, activation signal A may be ascertained in such a way that the drive and/or steering of the mobile robot is/are activated in such a way that the at least semi-autonomous robot, for example, prevents a collision with objects identified by artificial neural network 60.

Alternatively or in addition, the display unit may also be activated with activation signal A and, for example, the safe areas ascertained may be displayed. It is also possible, for example with a motor vehicle 100 that has non-automated steering, that display unit 10a is activated with activation signal A in such a way that it outputs a visual or acoustic warning signal if it is ascertained that motor vehicle 100 is about to collide with one of the reliably identified objects.

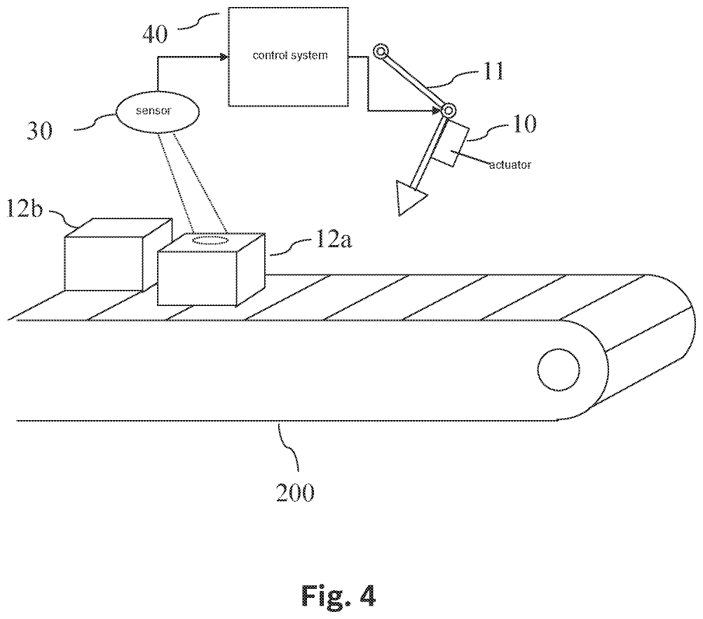

FIG. 4 shows one exemplary embodiment, in which control system 40 is used for activating a manufacturing machine 11 of a manufacturing system 200 by activating an actuator 10 that controls this manufacturing machine 11. Manufacturing machine 11 may, for example, be a machine for punching, sawing, drilling and/or cutting.

Sensor 30 may then, for example, be a visual sensor, which detects properties of manufactured products 12a, 12b, for example. It is possible that these manufactured products 12a, 12b are movable. It is possible that actuator 10 controlling manufacturing machine 11 is activated as a function of an assignment of detected manufactured products 12a, 12b, so that manufacturing machine 11 accordingly executes a subsequent processing step of the correct one of manufactured products 12a, 12b. It is also possible that by identifying the correct properties of the same one of manufactured products 12a, 12b (i.e., without a misclassification), manufacturing machine 11 accordingly adapts the same manufacturing step for a processing of a subsequent manufactured product.

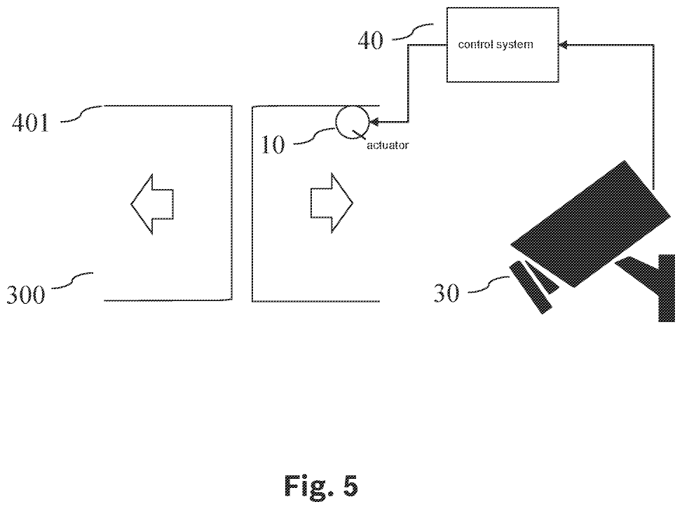

FIG. 5 shows one exemplary embodiment, in which control system 40 is used for controlling an access system 300. Access system 300 may include a physical access control, for example, a door 401. Video sensor 30 is configured to detect a person. With the aid of object identification system 60, it is possible to interpret this detected image. If multiple persons are detected simultaneously, it is possible by assigning the persons (i.e., the objects) to one another to particularly reliably ascertain, for example, the identity of the persons, for example, by an analysis of their movements. Actuator 10 may be a lock, which releases or does not release the access control as a function of activation signal A, for example, opens or does not open door 401. For this purpose, activation signal A may be selected as a function of the interpretation of object identification system 60, for example, as a function of the ascertained identity of the person. A logical access control, instead of the physical access control, may also be provided.

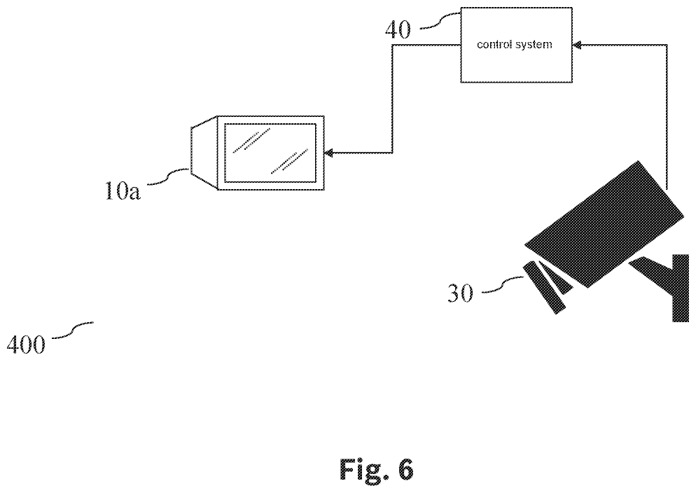

FIG. 6 shows one exemplary embodiment, in which control system 40 is used for controlling a monitoring system 400. This exemplary embodiment differs from the exemplary embodiment depicted in FIG. 5 in that instead of actuator 10, display unit 10a is provided, which is activated by control system 40. For example, an identity of the objects recorded by video sensor 30 may be reliably ascertained by artificial neural network 60 in order as a function thereof to deduce which ones are suspicious, and activation signal A may then be selected in such a way that this object is displayed highlighted in color by display unit 10a.

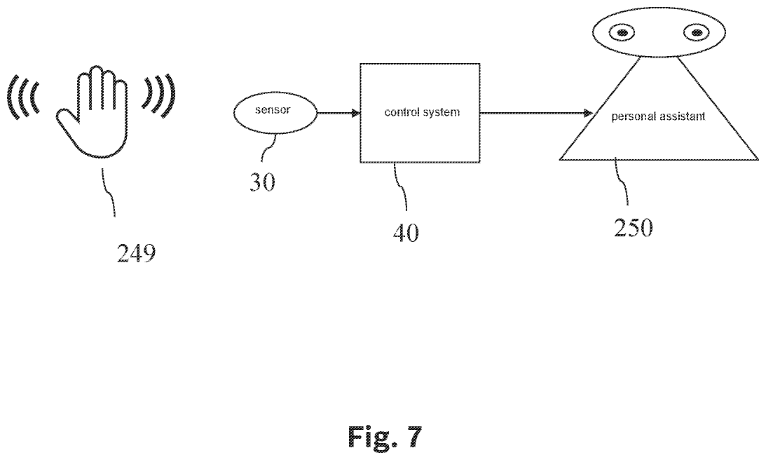

FIG. 7 shows one exemplary embodiment, in which control system 40 is used for controlling a personal assistant 250. Sensor 30 is preferably a visual sensor, which receives images of a gesture of a user 249.

Control system 40 ascertains activation signal A of personal assistant 250 as a function of the signals of sensor 30, for example, by the neural network carrying out a gesture recognition. This ascertained activation signal A is then transmitted to personal assistant 250 and it is thus activated accordingly. This ascertained activation signal A may, in particular, be selected in such a way that it corresponds to an assumed desired activation by user 249. This assumed, desired activation may be ascertained as a function of the gesture recognized by artificial neural network 60. Control system 40 may then select control signal A as a function of the assumed desired activation for transmission to personal assistant 250 and/or may select activation signal A for transmission to the personal assistant in accordance with assumed desired activation 250.

This corresponding activation may, for example, involve personal assistant 250 retrieving pieces of information from a database and reproducing them in a receivable manner for user 249.

Instead of personal assistant 250, a household appliance (not depicted), in particular, a washing machine, a stove, an oven, a microwave or a dishwasher, may also be provided in order to be activated accordingly.

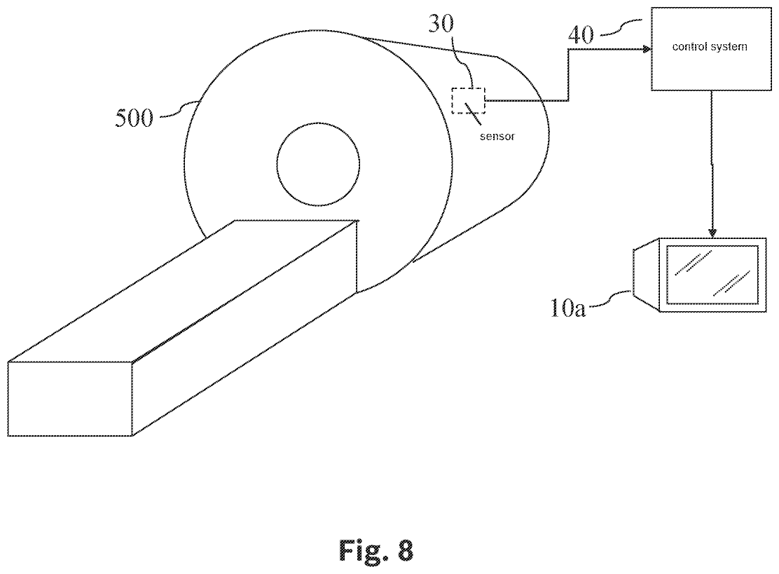

FIG. 8 shows one exemplary embodiment, in which control system 40 is used for controlling a medical imaging system 500, for example, an MRT device, x-ray device or ultrasound device. Sensor 30 may, for example, be provided in the form of an imaging sensor, display unit 10a is activated by control system 40. For example, it may be ascertained by neural network 60 whether an area recorded by the imaging sensor is conspicuous, and activation signal A is then selected in such a way that this area is displayed highlighted in color by display unit 10a.

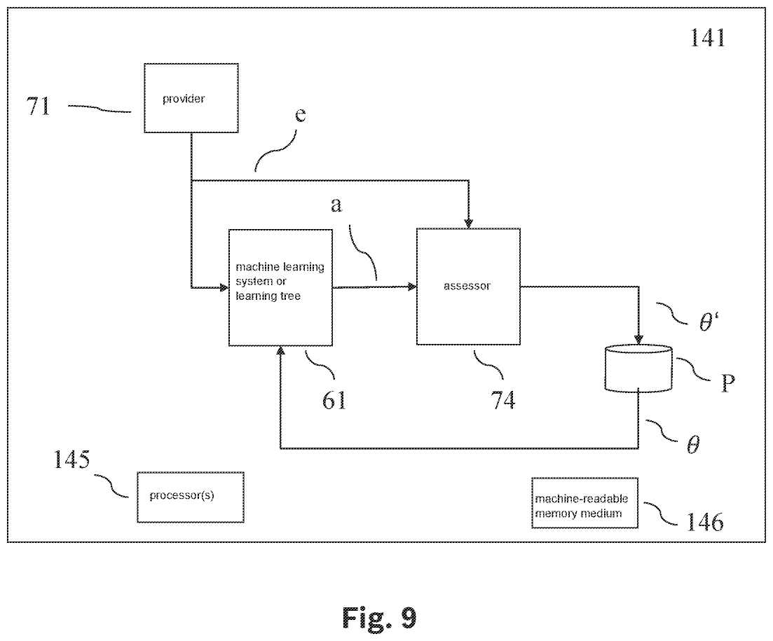

FIG. 9 shows one possible design of a training device 141 for training the machine learning system according to step S25 or of the decision tree according to step S23. This device is parameterized with parameters θ, which are provided by parameter memory P.

Training device 141 includes a provider 71, which provides input images e from a training data set. Input images e are fed to the machine learning system or decision tree 61 to be trained, which ascertains output variables a therefrom. Output variables a and input images e are fed to an assessor 74, which ascertains therefrom via an optimization method as described in corresponding steps S25/S23 new parameters θ, which are transmitted to parameter memory P where they replace parameters θ.

The methods carried out by training device 141, implemented as a computer program, may be stored on a machine-readable memory medium 146 and carried out by a processor 145.

The term “computer” encompasses arbitrary devices for executing predefinable calculation rules. These calculation rules may be present in the form of software, or in the form of hardware, or also in a mixed form of software and hardware.

What is claimed is:

1. A computer-implemented method for creating a system, which is suitable for creating, in an automated manner, a machine learning system for computer vision, the method comprising the following steps:
providing predefined hyperparameters, the hyperparameters including at least one first parameter, which characterizes which optimization method is used, and one second parameter, which characterizes of what type of the machine learning system is;
determining an optimal parameterization of the hyperparameters using BOHB (Bayesian optimization (BO) and Hyperband (HB)) for each single training data set of a plurality of different training data sets for computer vision;
assessing all of the optimal parameterizations on all training data sets of the plurality of different training data sets using a normalized metric;
creating a matrix, the matrix including the normalized metric for each of the optimal parameterizations and for each of the training data sets;
determining meta-features for each of the training data sets, the meta-features characterizing at least one of the following properties of the training data sets: image resolution, number of classes, number of training points/test data points, number of video frames;
initializing a system including a decision tree; and
optimizing the decision tree as a function of the meta-features and of the matrix, so that the decision tree outputs which of the determined optimal parameterizations using BOHB is a suitable parameterization for the meta-features.

2. The method as recited in claim 1, wherein parameters of the decision tree are optimized using AutoFolio.

3. The method as recited in claim 1, wherein an average value of the normalized metric across the plurality of training data sets is determined, one of the determined parameterizations of the hyperparameters being selected using BOHB, whose normalized metric comes closest to the average value, the normalized metric of the selected parameterization for all training data sets being added to the matrix.

4. The method as recited in claim 1, wherein an average value of the normalized metric across the plurality of the training data sets is determined, one of the determined parameterizations of the hyperparameters being selected using BOHB, which for the normalized metric, exhibits on average for all training data sets a greatest improvement of the normalized metric compared to the average value of the normalized metric, the normalized metric of the selected parameterization for all training data sets being added to the matrix.

5. The method as recited in claim 1, wherein a subset of meta-features of the plurality of the meta-features is determined with using a Greedy algorithm and the decision tree determines a suitable parameterization as a function of the subset of the meta-features and of the matrix.

6. The method as recited in claim 1, wherein a further training data set is provided, meta-features for the further training data set being determined, a suitable parameterization being subsequently determined using the decision tree as a function of the meta-features for the further training data set and of the matrix, the machine learning system being created based on the suitable parameterization and being trained on the further training data set.

7. The method as recited in claim 1, wherein the machine learning system is created based on the first parameter, and an optimization algorithm for the machine learning system is selected based on the second parameter and parameterized in accordance with the output suitable parameterization.

8. The method as recited in claim 1, wherein the hyperparameters further include parameters, which characterize: a batch size, and/or a number of data points to be used for training, and/or a learning rate, and/or a number of data points according to which an efficiency of the machine learning system is to be evaluated, and/or a relationship of parameters of the machine learning system that remain unchanged during training of the machine learning system and/or a weight decay.

9. A non-transitory machine-readable memory medium on which is stored a computer program for creating a system, which is suitable for creating, in an automated manner, a machine learning system for computer vision, the computer program, when executed by a computer, causing the computer to perform the following steps:
providing predefined hyperparameters, the hyperparameters including at least one first parameter, which characterizes which optimization method is used, and one second parameter, which characterizes of what type of the machine learning system is;
determining an optimal parameterization of the hyperparameters using BOHB (Bayesian optimization (BO) and Hyperband (HB)) for each single training data set of a plurality of different training data sets for computer vision;
assessing all of the optimal parameterizations on all training data sets of the plurality of different training data sets using a normalized metric;
creating a matrix, the matrix including the normalized metric for each of the optimal parameterizations and for each of the training data sets;
determining meta-features for each of the training data sets, the meta-features characterizing at least one of the following properties of the training data sets: image resolution, number of classes, number of training points/test data points, number of video frames;
initializing a system including a decision tree; and
optimizing the decision tree as a function of the meta-features and of the matrix, so that the decision tree outputs which of the determined optimal parameterizations using BOHB is a suitable parameterization for the meta-features.

10. A device configured to create a system, which is suitable for creating, in an automated manner, a machine learning system for computer vision, the method comprising the following steps:
providing predefined hyperparameters, the hyperparameters including at least one first parameter, which characterizes which optimization method is used, and one second parameter, which characterizes of what type of the machine learning system is;
determining an optimal parameterization of the hyperparameters using BOHB (Bayesian optimization (BO) and Hyperband (HB)) for each single training data set of a plurality of different training data sets for computer vision;
assessing all of the optimal parameterizations on all training data sets of the plurality of different training data sets using a normalized metric;
creating a matrix, the matrix including the normalized metric for each of the optimal parameterizations and for each of the training data sets;
determining meta-features for each of the training data sets, the meta-features characterizing at least one of the following properties of the training data sets: image resolution, number of classes, number of training points/test data points, number of video frames;
initializing a system including a decision tree; and
optimizing the decision tree as a function of the meta-features and of the matrix, so that the decision tree outputs which of the determined optimal parameterizations using BOHB is a suitable parameterization for the meta-features.
